(19) United States
(12) Patent Application Publication
(10) Pub. No.: US 2011/0209096 A1
(43) Pub. Date: Aug. 25, 2011

(54) INPUT DEVICE, INPUT METHOD, AND PROGRAM

(75) Inventor: Katsuya HYODO, Kanagawa (JP)

(73) Assignee: Sony Corporation, Tokyo (JP)

(21) Appl. No.: 12/983,484

(22) Filed: Jan. 3, 2011

(30) Foreign Application Priority Data
Feb. 22, 2010 (JP) 2010-036371

(51) Int. Cl. G09G 5/08

(52) U.S. Cl. 715/856; 345/157

(57) ABSTRACT

An input device includes a pointer movement control unit that controls movement of a pointer to select a component in a GUI represented spatially on a two dimensional screen based on a user operation, and a movement direction setting unit that sets a direction of movement of the pointer to be in a first direction or a second direction vertical to the first direction of the GUI in accordance with an orientation of the input device.

### BACKGROUND OF THE INVENTION

1. Field of the Invention

The present invention relates to an input device, an input, and a program, and particularly to an input device, an input method, and a program that enables to dramatically improve the operability of a GUI that is represented spatially and in which an input in the depth direction is desired.

2. Description of the Related Art

In the past, a focus of an operation screen displayed on the television used to be allowed to move in four directions corresponding to an arrow key by, for example, pressing the arrow key of a remote controller. There also is a technique that is capable of an input in four or more directions using a controller equipped with an analog stick.

Further, a technique is also proposed in which rotation of an input device, such as a remote controller, enables a user interface to be controlled by controlling the movement of a pointer based on the yaw angle speed value and the roll angle speed value of the input device (for example, refer to Japanese Unexamined Patent Application Publication (Translation of PCT Application) No. 2008-541268).

### SUMMARY OF THE INVENTION

However, in recent years, user interfaces have been increasingly higher in performances, and for example, there also are a GUI (graphical user interface) spatially represented on a two dimensional screen and the like.

In related techniques, inputs were accepted only in the directions parallel to one certain plane within a three dimensional space in a GUI represented spatially. For example, four keys of an arrow key in the past correspond to the four directions (directions of up, down, right, and left) in the XY plane and do not support an input in the direction of the Z axis (in the depth direction).

Alternatively, in related techniques, in a case of carrying out an input in the depth direction within a three dimensional space, it used to be desirable to operate a key exclusively for the depth direction or to separately carry out an operation for switching the input direction.

In related techniques, due to such restrictions, there used to be a problem, in a GUI that is represented spatially and in which an input in the depth direction is desired, that the operation of the GUI was felt troublesome.

It is desirable to dramatically improve the operability of a GUI that is represented spatially and in which an input in the depth direction is desired.

According to an embodiment of the present invention, an input device includes pointer movement control means for controlling movement of a pointer to select a component in a GUI represented spatially on a two dimensional screen based on a user operation, and movement direction setting means for setting a direction of movement of the pointer to be in a first direction or a second direction vertical to the first direction of the GUI in accordance with an orientation of the input device.

It is possible that the input device further includes angle calculation means for calculating, taking an axis set inside the input device as a basis, an angle between the axis and a ground surface. The movement direction setting means specifies the orientation of the input device by comparing the calculated angle with a threshold set in advance.

It is possible that the input device further includes specification result sending means for sending the orientation specified by the movement direction setting means to an instrument having a screen of the GUI.

It is possible that the pointer movement control means is configured as an arrow key, and a direction of movement of the pointer by an up button and a down button included in the arrow key is set to be in the first direction or in the second direction.

According to another embodiment of the present invention, an input method includes the step of setting a direction of movement of a pointer controlled in movement by pointer movement control means that controls the movement of the pointer to select a component in a GUI represented spatially on a two dimensional screen based on a user operation to be in a first direction or in a second direction vertical to the first direction of the GUI in accordance with an orientation of an input device.

According to still another embodiment of the present invention, there is provided a program to make a computer function as an input device which includes pointer movement control means for controlling movement of a pointer to select a component in a GUI represented spatially on a two dimensional screen based on a user operation, and movement direction setting means for setting a direction of movement of the pointer to be in a first direction or a second direction vertical to the first direction of the GUI in accordance with an orientation of the input device.

In the embodiments of the present invention, movement of a pointer to select a component in a GUI represented spatially on a two dimensional screen is controlled based on a user operation, and the direction of movement of the pointer is set, in accordance with an orientation of an input device, in a first direction or in a second direction vertical to the first direction of the GUI.

According to the embodiments of the present invention, the operability of a GUI that is represented spatially and in which an input in the depth direction is desired can be improved dramatically.

### BRIEF DESCRIPTION OF THE DRAWINGS

FIG. 1 illustrates an example of a remote controller in the past;

FIG. 2 illustrates an example of a game controller in the past;

FIG. 3 illustrates an arrow key in FIG. 1 in a simplified manner;

FIG. 4 illustrates a direction of movement on a GUI screen corresponding to an operation of each button of the arrow key in FIG. 3;

FIG. 5 is a block diagram illustrating a configuration example of an input device according to an embodiment of the present invention;

FIG. 6 illustrates a GUI operated by an input device of an embodiment of the present invention;

FIG. 7 illustrates a GUI displayed on a screen of a television receiver in FIG. 6;

FIG. 8 illustrates an angle calculated by an angle sensor;

FIG. 9 is a flowchart describing operation input processing;

FIG. 10 illustrates another display embodiment of a GUI displayed on the screen of the television receiver in FIG. 6;

FIG. 11 illustrates still another display embodiment of a GUI displayed on the screen of the television receiver in FIG. 6; and

FIG. 12 is a block diagram illustrating a configuration example of a personal computer.

### DESCRIPTION OF THE PREFERRED EMBODIMENTS

A description is given below to embodiments of the present invention with reference to the drawings.

Firstly, a description is given to input devices, such as a remote controller and a game controller, in the past.

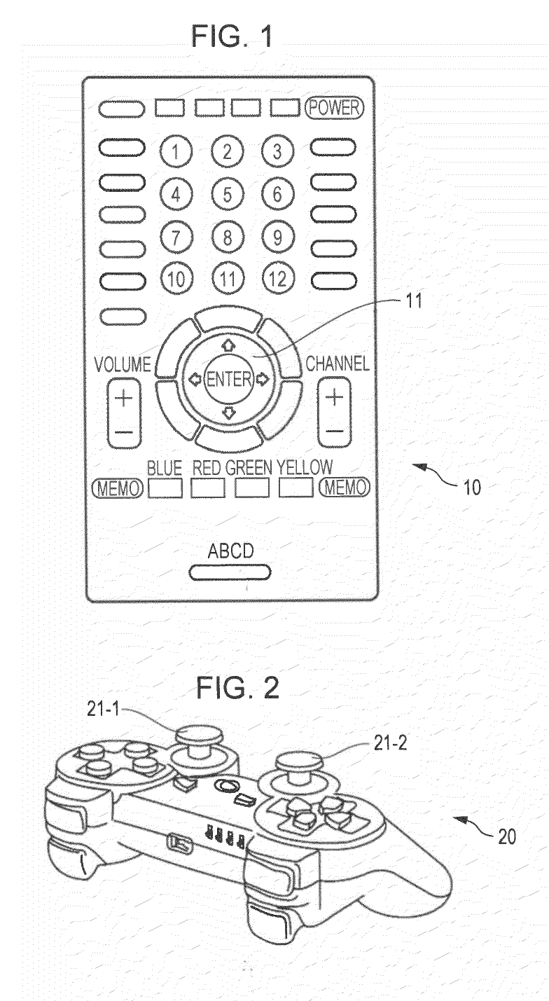

FIG. 1 illustrates an example of a remote controller in the past. A remote controller 10 is designed to receive, for example, an operation input of a user and send a signal corresponding to the operation input in an infrared signal or the like. This enables a user to operate a GUI (graphical user interface) displayed on, for example, a television receiver or the like by operating the remote controller 10.

As illustrated in FIG. 1, the remote controller 10 is provided with an arrow key 11 and is designed to enable to move, for example, a cursor, a focus position, and the like of a GUI by pressing a button (key) of the arrow key 11. That is, a cursor, a focus position, and the like of a GUI is moved in a direction (for example, a direction of up, down, right, or left) corresponding to each button of the arrow key 11.

FIG. 2 illustrates an example of a game controller in the past. A game controller 20 is also designed to, similar to the remote controller 10, receive an operation input of a user and send a signal corresponding to the operation input.

As illustrated in FIG. 2, the game controller 20 is provided with an analog stick 21-1 and an analog stick 21-2. Here, these two are referred to as analog sticks 21 by being put together.

The analog sticks 21 can receive an operation input in any direction in an identical plane, different from the arrow key 11. By using the analog sticks 21, it also becomes possible to move, for example, a cursor, a focus position, and the like of a GUI in a single operation in an upper right direction or a lower left direction.

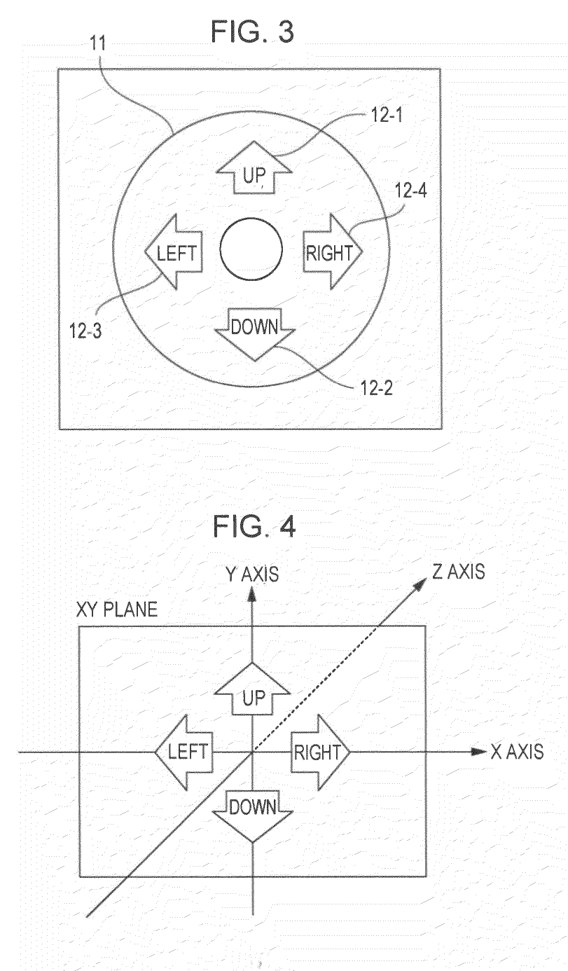

FIG. 3 illustrates the arrow key 11 in FIG. 1 in a simplified manner. In this example, the arrow key 11 is provided with an up button 12-1, a down button 12-2, a left button 12-3, and a right button 12-4.

FIG. 4 illustrates the direction of movement on a GUI screen corresponding to an operation of each button of the arrow key in FIG. 3. As illustrated in FIG. 4, corresponding to an operation of the up button 12-1 through the right button 12-4, a cursor or the like turns out to be moved in a direction of up, down, right, or left in the XY plane on the GUI screen.

However, in recent years, user interfaces are increasingly higher in performances, and for example, there also are a GUI represented spatially on a two dimensional screen and the like. In a case of such a GUI, not only an operation in the direction of up, down, right, or left in the XY plane but also an operation in a direction of the Z axis in FIG. 4 (depth direction in the screen) is desirable.

With that, an embodiment of the present invention enables to provide an input device, such as a remote controller and a game controller, in which not only operations in the directions of up, down, right, and left in the XY plane but also operations in the direction of the Z axis in FIG. 4 (depth direction in the screen) become possible.

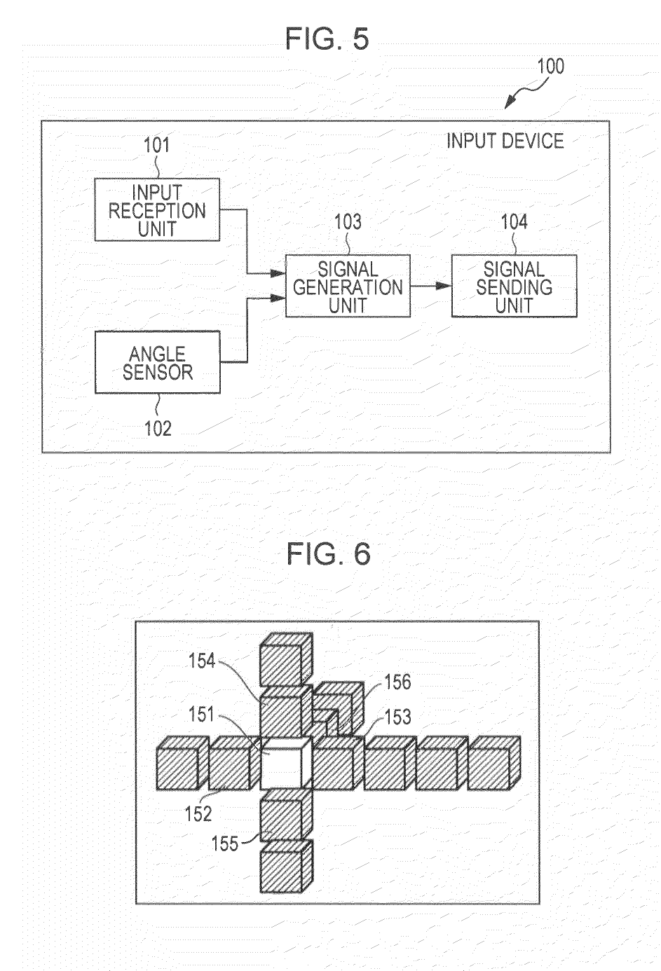

FIG. 5 is a block diagram illustrating a configuration example of an input device according to an embodiment of the present invention. An input device 100 illustrated in FIG. 5 is configured as, for example, a remote controller, a game controller, or the like, and for example, is designed to receive an operation input of a user and send a signal corresponding to the operation input in an infrared signal or the like. This enables a user to operate a GUI or the like displayed on, for example, a television receiver or the like by operating the remote controller 10.

As illustrated in FIG. 5, the input device 100 is provided with an input reception unit 101, an angle sensor 102, a signal generation unit 103, and a signal sending unit 104. The appearance of the input device 100 is configured, for example, similar to that of the remote controller 10 illustrated in FIG. 1.

The input reception unit 101 is configured with, for example, an arrow key, an analog stick, and the like, and is designed to generate a signal in a direction corresponding to an operation of a button, a stick, or the like to supply to the signal generation unit 103. The input reception unit 101 enables to receive an input in any direction in one two-dimensional space (for example, the XY plane in FIG. 4) or in a predetermined direction set in advance.

The input reception unit 101 may also be provided with other buttons, keys, and the like as desired.

The angle sensor 102 has a configuration having, for example, a gyro sensor and the like inside and is designed to enable calculation of an angle of the input device 100 relative to the horizontal plane. The angle sensor 102 is designed to calculate, taking an axis set inside the input device 100 as a basis for example, an angle between the axis and the ground surface, thereby outputting a signal expressing the calculated angle to the signal generation unit 103.

The signal generation unit 103 has a configuration having a processor, a memory, and the like inside and generates an operation signal based on the signals supplied from the input reception unit 101 and the angle sensor 102. The operation signal generated here also includes, for example, a signal and the like to move a cursor, a focus position, or the like of a GUI displayed on a television receiver or the like.

In a case of generating a signal to move, for example, a cursor, a focus position, or the like of a GUI, the signal generation unit 103 is designed to generate an operation signal by specifying the direction of movement.

The signal sending unit 104 is designed to send the operation signal generated by the signal generation unit 103 to an instrument operated using the input device 100 (for example, an instrument to display the GUI) or the like. The signal sending unit 104 is designed to send, for example, the operation signal generated by the signal generation unit 103 to a light receiving unit of a television receiver to display the GUI as an infrared signal or the like.

By operating the input device 100, as illustrated in FIG. 6 for example, it becomes possible to operate a GUI displayed on a screen of a television receiver 130. In the example of FIG. 6, a GUI is displayed that is represented spatially on a two dimensional screen of the television receiver 130. That is, in the example of FIG. 6, an operation in respective directions of the X axis direction, the Y axis direction, and the Z axis direction in FIG. 6 is designed to be received as a direction of an operation by the input device 100.

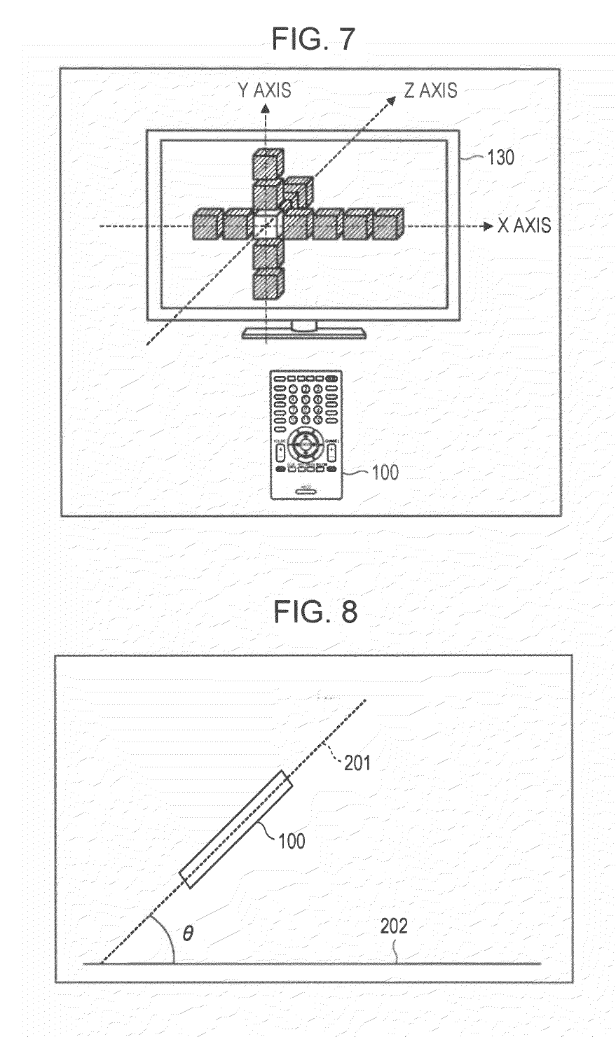

FIG. 7 illustrates a GUI displayed on a screen of the television receiver 130 in FIG. 6. This GUI is supposed to select any one of a plurality of boxes (cubes) shown on the screen. In this case, it is expressed that a box 151 is focused and the box 151 is selected.

The input device 100 generates a signal to move the focus position in the GUI illustrated in FIG. 7 to send it to the television receiver 130. At this time, it is designed to generate the signal by specifying the direction of movement of the focus position of the GUI as described above.

For example, the input device 100 is designed to have the input reception unit 101 configured with an arrow key where the arrow key is provided with an up button, a down button, a left button, and a right button.

In a case that a user presses the left button, the focus position of the GUI in FIG. 7 is moved to the box 152 by the operation signal sent from the input device 100. In another case that a user presses a right button, the focus position of the GUI in FIG. 7 is moved to the box 153 by the operation signal sent from the input device 100.

On the other hand, in a case of pressing the up button or the down button, the direction of movement of the focus position is designed to be set in accordance with the orientation of the input device 100. Here, the orientation of the input device 100 corresponds to the angle calculated by the angle sensor 102 described above.

That is, as illustrated in FIG. 8, the degree θ of an angle between a broken line 201, which is an axis of the input device 100, and a horizontal line 202 is calculated by the angle sensor 102. For example, in a case that the angle θ is equal to or greater than a threshold set in advance, the direction of movement of the focus position when the up button or the down button is pressed is set to be in the direction of the Y axis in FIG. 6. In contrast, in a case that the angle θ is less than a threshold set in advance, the direction of movement of the focus position when the up button or the down button is pressed is set to be in the direction of the Z axis in FIG. 6.

In the case that the angle θ is equal to or greater than a threshold set in advance, the orientation of the input device 100 can be considered to be close to vertical. Accordingly, the vertical direction for a user operating the arrow key of the input device 100 is considered to be an image of the direction of the Y axis in FIG. 6. With that, in the case that the angle θ is equal to or greater than a threshold set in advance, the focus position in FIG. 7 is moved to the box 154 when the up button of the arrow key is pressed, for example, and the focus position in FIG. 7 is moved to the box 155 when the down button of the arrow key is pressed.

In contrast, in the case that the angle θ is less than a threshold set in advance, the orientation of the input device 100 can be considered to be close to horizontal. Accordingly, the vertical direction for a user operating the arrow key of the input device 100 is considered to be an image of the direction of the Z axis in FIG. 6. With that, in the case that the angle θ is less than a threshold set in advance, the focus position in FIG. 7 is moved to the box 156 when the up button of the arrow key is pressed, for example.

In other words, a user can change the direction of movement of the focus corresponding to an operation in a vertical direction by making the orientation of the input device 100 close to be horizontal or making the orientation of the input device 100 close to be vertical.

In such a manner, a user can easily move a focus position, a cursor, or the like of a GUI in the direction of his/her image.

In related techniques, an input is accepted only in the directions parallel to one certain plane within a three dimensional space. For example, four keys of an arrow key in the past correspond to four directions (directions of up, down, right, and left) in the XY plane and it used not to be possible to input in the direction of the Z axis (depth direction).

Alternatively, in related techniques, in a case of carrying out an input in the depth direction within a three dimensional space, it used to be desirable to operate a key exclusive for the depth direction or to separately carry out an operation for input direction switching.

Such techniques in the past, due to such restrictions, used to have a problem that an operation of a GUI is felt troublesome in a GUI that is represented spatially and in which an input in the depth direction is desired.

Compared to this, according to the embodiment of the present invention, only by changing the orientation of the input device 100, a user can easily move a focus position, a cursor, and the like of a GUI in a direction of his/her image. Therefore, according to the embodiment of the present invention, it becomes possible to dramatically improve the operability of a GUI that is represented spatially and in which an input in the depth direction is desired.

Although a description is given to a GUI as an example in which a predetermined box is selected by moving a focus in this example, components of a GUI are not limited to boxes and selection is not desirable to be made by focusing in all cases. The point is that the embodiment of the present invention is applicable to those in which a component of a GUI is selected by moving a predetermined pointer.

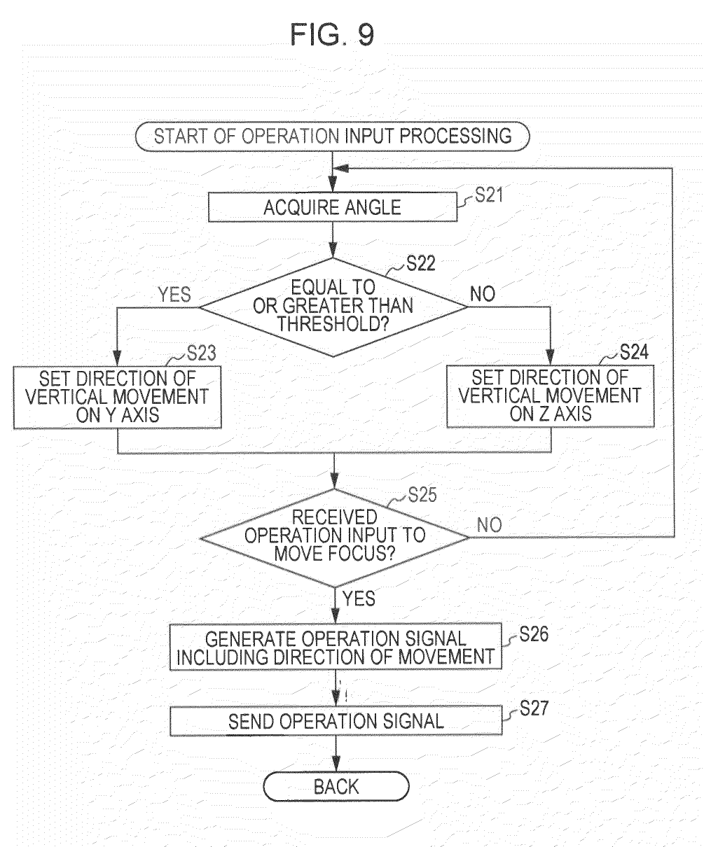

Next, with reference to the flowchart in FIG. 9, a description is given to an example of operation input processing by the input device 100.

In step S21, the angle sensor 102 acquires an angle of the input device 100 relative to the horizontal plane by calculation. At this point, as described above with reference to FIG. 8 for example, the degree θ of the angle between the broken line 201, which is an axis of the input device 100, and the horizontal line 202 is calculated by the angle sensor 102.

In step S22, the signal generation unit 103 determines whether or not the angle acquired by the process of step S21 is equal to or greater than a threshold.

When the angle acquired by the process of step S21 is determined to be equal to or greater than a threshold in step S22, the process goes on to step S23 and the signal generation unit 103 sets the Y axis of a GUI as a direction of movement corresponding to the vertical operation of the input reception unit 101.

For example, in a case of the angle θ in FIG. 8 being equal to or greater than a threshold set in advance, the direction of the Y axis in FIG. 6 is set as the direction of movement of the focus position in the GUI when an up button or a down button is pressed.

On the other hand, in a case of the angle acquired by the process of step S21 being determined as not equal to or greater than a threshold (as less than a threshold) in step S22, the process goes on to step S24 and the signal generation unit 103 sets the Z axis of a GUI as a direction of movement corresponding to the vertical operation of the input reception unit 101.

For example, in a case of the angle θ in FIG. 8 being less than a threshold set in advance, the direction of the Z axis in FIG. 6 is set as the direction of movement of the focus position of the GUI when an up button or a down button is pressed.

In step S25, the signal generation unit 103 determines whether or not an operation input to move the focus is received based on a signal supplied from the input reception unit 101 and stands by until determined as an operation input to move the focus is received.

When an operation input to move the focus is determined to have been received in step S25, the process goes on to step S26.

In step S26, the signal generation unit 103 generates an operation signal including a direction of movement. At this point, the direction of movement corresponding to the vertical operation of the input reception unit 101 is made to be the direction of movement set in the process of step S23 or step S24 and an operation signal is thus generated.

In step S27, the signal sending unit 104 sends the operation signal generated in the process of step S26.

This causes, in a case that a user presses a left button for example, the focus position of the GUI in FIG. 7 is moved to the box 152 by the operation signal sent from the input device 100. In another case that a user presses a right button, the focus position of the GUI in FIG. 7 is moved to the box 153 by the operation signal sent from the input device 100.

The focus position in FIG. 7 is moved to the box 154 when an up button of an arrow key is pressed while the orientation of the input device is made close to vertical, and the focus position in FIG. 7 is moved to the box 155 when a down button of an arrow key is pressed. On the other hand, the focus position in FIG. 7 is moved to the box 156 when an up button of an arrow key is pressed while the orientation of the input device is made close to horizontal.

In a case that the direction of movement is set in the process of step S23 or step S24 described above, a signal may also be sent that expresses the direction of movement set for the television receiver 130 at that point.

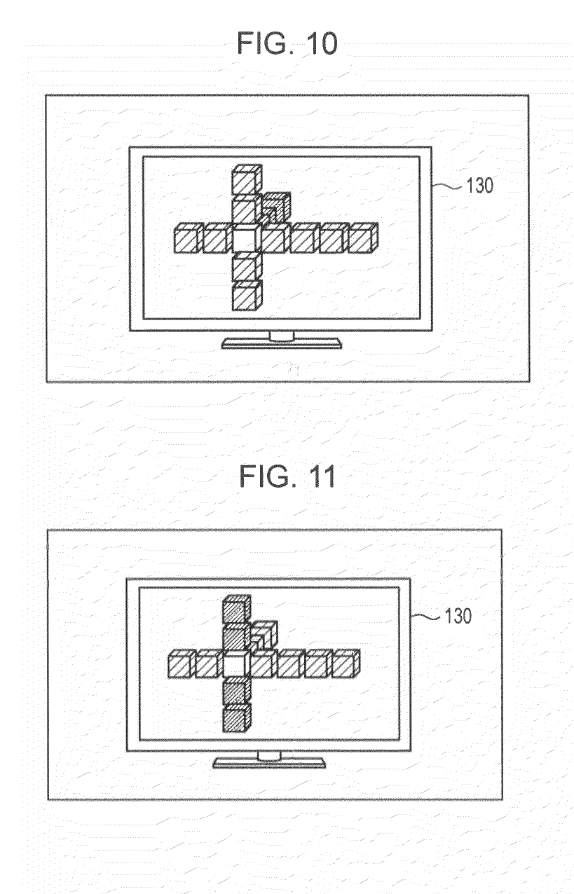

For example, in a case that the direction of movement is set to be the Y axis in the process of step S23 and a signal expressing the direction of movement is sent, the GUI may also be displayed in the television receiver 130 as illustrated in FIG. 10. FIG. 10 illustrates another display embodiment of a GUI displayed on the screen of the television receiver 130 in FIG. 6.

In the example of FIG. 10, the boxes aligned in the direction of the X axis or in the direction of the Y axis, among the boxes of the GUI in the television receiver 130, are displayed relatively brightly, and the boxes displayed in alignment with the direction of the Z axis are displayed relatively darkly.

In such a manner, when carrying out an operation of movement in a vertical direction at the present timing, a user can recognize that the focus position of the GUI in FIG. 10 is moved in a direction of the Y axis (verticality).

For example, in a case that the direction of movement is set to be the Z axis in the process of step S24 and a signal expressing the direction of movement is sent, a GUI may also be displayed as illustrated in FIG. 11 in the television receiver 130. FIG. 11 illustrates still another display embodiment of a GUI displayed on the screen of the television receiver 130 in FIG. 6.

In the example of FIG. 11, the boxes aligned in the direction of the X axis or in the direction of the Z axis, among the boxes of the GUI in the television receiver 130, are displayed relatively brightly, and the boxes displayed in alignment with the direction of the Y axis are displayed relatively darkly.

In such a manner, when carrying out an operation of movement in a vertical direction at the present timing, a user can recognize that the focus position of the GUI in FIG. 11 is moved in a direction of the Z axis (depth).

The operation input processing is thus executed.

In the above description, an example is described in which an operation in a vertical direction received by the input reception unit 101 corresponds to, in accordance with the orientation of the input device 100, movement of the focus in the direction of the Y axis (verticality) or movement of the focus in the direction of the Z axis (depth) of the GUI.

However, it is also allowed that an operation in a lateral direction received by the input reception unit 101 corresponds to, in accordance with the orientation of the input device 100 for example, movement of the focus in the direction of the X axis (lateral) or movement of the focus in the direction of the Z axis (depth) of the GUI.

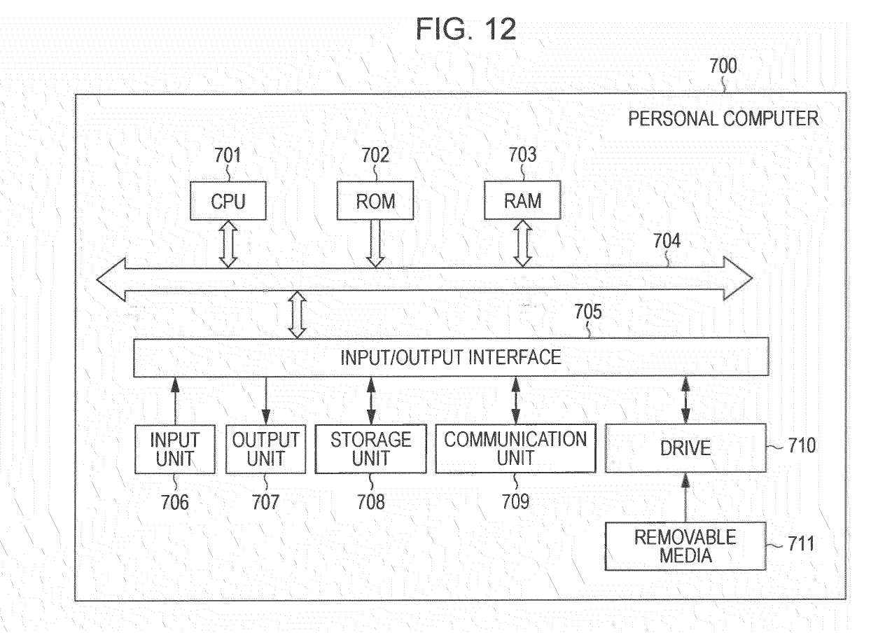

The series of processing described above can be executed by hardware and can also be executed by software. In a case of executing the series of processing described above by software, a program configuring the software is installed to a computer built in exclusive hardware from a network or a storage medium. By installing various programs, they are installed to a personal computer 700 for general purposes or the like that is capable of executing various functions, and for example, as illustrated in FIG. 12 from a network or a storage medium.

In FIG. 12, a CPU (central processing unit) 701 executes various processes in accordance with programs stored in a ROM (read only memory) 702 or programs loaded from the storage unit 708 to a RAM (random access memory) 703. In the RAM 703, data and the like are also stored appropriately that is desired by the CPU 701 to execute various processes.

The CPU 701, the ROM 702, and the RAM 703 are connected with each other via a bus 704. The bus 704 is also connected with an input/output interface 705.

The input/output interface 705 is connected with an input unit 706 composed of a key board, a mouse, and the like, a display composed of an LCD (liquid crystal display) and the like, and an output unit 707 composed of a speaker and the like. The input/output interface 705 is also connected with a storage unit 708 configured with a hard disk and the like and a communication unit 709 configured with a modem, a network interface card such as a LAN card, and the like. The communication unit 709 carries out communication processing via a network including the Internet.

The input/output interface 705 is also connected with a drive 710 as desired, in which a removable media 711 is appropriately mounted such as a magnetic disk, an optical disk, a magnetooptical disk, or a semiconductor memory. Then, a computer program read out from such a removable media is installed to the storage unit 708 as desired.

In a case of executing the series of processing described above by software, a program configuring the software is installed from a network such as the Internet or a storage medium composed of the removable media 711 or the like.

Such a storage medium includes, not only those configured with the removable media 711 composed of a magnetic disk (including a Floppy Disk®), an optical disk (including a CD-ROM (compact disk-read only memory) and a DVD (digital versatile disk)), a magnetooptical disk (including an MD (Mini-Disk)®), a semiconductor memory, or the like with a program stored therein that is illustrated in FIG. 12 and distributed to deliver a program to a user separately from the device body, but also those configured with the ROM 702 that is delivered to a user while being built in the device body in advance with a program stored therein, hard disk included in the storage unit 708, or the like.

The series of processing described above in this specification includes naturally the processing conducted in order according to the description in time series and also processing not processed in time series in all cases but executed in parallel or separately.

The present application contains subject matter related to that disclosed in Japanese Priority Patent Application JP 2010-036371 filed in the Japan Patent Office on Feb. 22, 2010, the entire contents of which are hereby incorporated by reference.

Embodiments of the present invention are not limited to the embodiments described above but various modifications are available without departing from the spirit of the present invention.

What is claimed is:

1. An input device, comprising:
pointer movement control means for controlling movement of a pointer to select a component in a GUI represented spatially on a two dimensional screen based on a user operation; and
movement direction setting means for setting a direction of movement of the pointer to be in a first direction or a second direction vertical to the first direction of the GUI in accordance with an orientation of the input device.

2. The input device according to claim 1, further comprising angle calculation means for calculating, taking an axis set inside the input device as a basis, an angle between the axis and a ground surface,
wherein the movement direction setting means specifies the orientation of the input device by comparing the calculated angle with a threshold set in advance.

3. The input device according to claim 1, further comprising specification result sending means for sending the orientation specified by the movement direction setting means to an instrument having a screen of the GUI.

4. The input device according to claim 1, wherein
the pointer movement control means is configured as an arrow key, and
a direction of movement of the pointer by an up button and a down button included in the arrow key is set to be in the first direction or in the second direction.

5. An input method, comprising the step of:
setting a direction of movement of a pointer controlled in movement by pointer movement control means that controls the movement of the pointer to select a component in a GUI represented spatially on a two dimensional screen based on a user operation to be in a first direction or in a second direction vertical to the first direction of the GUI in accordance with an orientation of an input device.

6. A program to make a computer function as an input device comprising:
pointer movement control means for controlling movement of a pointer to select a component in a GUI represented spatially on a two dimensional screen based on a user operation; and
movement direction setting means for setting a direction of movement of the pointer to be in a first direction or a second direction vertical to the first direction of the GUI in accordance with an orientation of the input device.

7. An input device, comprising:
a pointer movement control unit that controls movement of a pointer to select a component in a GUI represented spatially on a two dimensional screen based on a user operation; and
a movement direction setting unit that sets a direction of movement of the pointer to be in a first direction or a second direction vertical to the first direction of the GUI in accordance with an orientation of the input device.
